(19) United States
(12) Patent Application Publication
(10) Pub. No.: US 2003/0130749 A1
(43) Pub. Date: Jul. 10, 2003

(54) Multi-purpose configuration model

(76) Inventors: Albert Haag, Bad Duerkheim (DE); Wolfgang Kalthoff, Bad Schonborn (DE); Andreas Kraemer, Berlin (DE); Gerd Moser, Rauenberg (DE); Richard Knierim, Sinsheim (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/291,175

(22) Filed: Nov. 7, 2002

Related U.S. Application Data
(60) Provisional application No. 60/338,105, filed on Nov. 7, 2001.

(51) Int. Cl. G05B 13/02

(52) U.S. Cl. 700/31; 700/30

(57) ABSTRACT

Methods and apparatus, including computer program products, for a multi-purpose configuration model. A computer program product, tangibly stored on a machine-readable medium, for defining a configuration model for a product, includes instructions operable to cause a programmable processor to receive input. The product includes instructions to define, based on the input, a base component of the configuration model, the base component including information that describes the product. The product includes instructions to define, based on the input, a first component of the configuration model, the first component including information that describes the product and that is associated with a first business process.

This application claims the priority of U.S. Provisional Application Serial No. 60/338,105 filed Nov. 7, 2001, which is hereby incorporated by reference in its entirety.

### BACKGROUND

The present invention relates to data processing, and more particularly to product modeling.

Business enterprises can generally design, build, and sell one or more products such as, for example, a car. A product such as a car can be configurable. That is, the product can have characteristics that can be varied. For example, a characteristic of a car that can vary is the number of doors. The car can be a sedan or a coupe. There are other characteristics, such as engine size, wheel size, body color, and type of seats, that are configurable.

Business enterprises can use computer systems to facilitate operations such as product design. One example of such systems is a product modeling system. Generally, product modeling of a product refers to a process, usually implemented in a computer system, that defines a model that represents the product. Defining a configurable product can include, for example, specifying constraints, characteristics, and components of the product. The constraints and characteristics can be specified in a configuration model. The configuration model is generally some collection of information, including information, such as constraints and characteristics, needed to configure the product. The configuration model can be an element of the overall product model. The components of the product can be specified in a product structure that can also be an element of the overall product model.

The configuration model is generally the basis for configuring of a product. For example, the configuration model can include criteria that determine the configuration of the product. Criteria can include, for example, constraints specifying that a particular type of wheel must be used for a particular type of engine.

### SUMMARY

The present invention provides methods and apparatus, including computer program products, for a multi-purpose configuration model.

In general, in one aspect, a method implemented in a computer program application for changing a configuration model of a product includes receiving a configuration model. The configuration model includes a first component and at least a second component. The first component includes information for a first business process. The second component includes information for a second business process. The information of the first and the second component includes characteristics and characteristic values that describe the product and constraints specifying dependencies of the characteristics. The method includes receiving input that specifies a change to the configuration model. The method includes determining whether the change violates the characteristics and constraints of the configuration model.

In general, in another aspect, a computer program product for defining a configuration model for a product includes instructions operable to cause a programmable processor to receive input. The product includes instructions to define, based on the input, a base component of the configuration model, the base component including information that describes the product. The product includes instructions to define, based on the input, a first component of the configuration model, the first component including information that describes the product and that is associated with a first business process. The product is tangibly stored on a machine-readable medium.

In general, in another aspect, a method, implemented in a computer program application for modeling a product, includes defining a configuration model. The configuration model includes a first component and at least a second component. The first component includes information for a first business process. The second component includes information for a second business process. The information of the first and the second component includes one or more of characteristics and characteristic values that describe the product and rules specifying dependencies of the characteristics. The first business process defines a baseline configuration for the product and the second business process defining a variation from the baseline configuration. The method includes receiving input that specifies a change to the configuration model. The method includes determining whether the change violates the characteristics and rules of the configuration model.

In general, in another aspect, a computer program product for defining a configuration model for a product includes instructions operable to cause a programmable processor to receive input. The product includes instructions to define, based on the input, a base component of the configuration model, the base component including information that describes a baseline configuration for the product. The product includes instructions to define, based on the input, a first component of the configuration model. The first component includes information that describes a variation to the baseline configuration of the product and that is associated with a first business process. The first component includes restrictions on accessing and modifying the variation information. The product is tangibly stored on a machine-readable medium.

The invention can be implemented to realize one or more of the following advantages. A system in accordance with the invention provides a multi-purpose configuration model. The configuration model can be used for different processes. For example, the configuration model can be used for different business processes, which can include product design, marketing, sales, and production. Processes can be different as a result of being performed by different organization units or as a result of being performed for different business areas.

The system can provide information based on a role of a user. A user, as used in this specification, can be a human operator or another entity, such as a computer program. The system can provide only information that is relevant to processes associated with the role. For example, the system can provide price information but not production information to users that have marketing or sales roles.

The system can provide information based on an access authorization level of the user. The system, for example, can include sensitive information, such as profit margin, in the product model and allow only a particular group of users, such as, for example, vice presidents and accountants, to view the information.

The system, in response to user input or input from another source, can change a configuration model. For example, the system can add characteristics to the configuration model, restrict ranges of values of a characteristic, set default values for a characteristic, and add constraints to the configuration model.

The system can present different views of the configuration model. Each view can correspond to and can be used for a particular process.

The system can reduce modeling redundancy caused by having different organizational units, such as different sales organizations or business partners, use different models while sharing data through, for example, a parent organization.

The system can provide efficient communication between organizations. Characteristics, products, and other model information that are common to the different views of the organization are visible to both organizations.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 shows a configuration model that includes different components.

FIG. 2 shows an implementation of the configuration model.

FIGS. 3A-E show examples of information included in components of the implementation.

FIG. 4A-E show examples of views of the implementation.

FIG. 5. illustrates role-based configuration modeling.

FIG. 6. illustrates access-authorization-based configuration modeling.

FIG. 7. shows a method for changing a configuration model.

FIGS. 8A-C illustrates different techniques for defining constraints.

Like reference numbers and designations in the various drawings indicate like elements.

### DETAILED DESCRIPTION

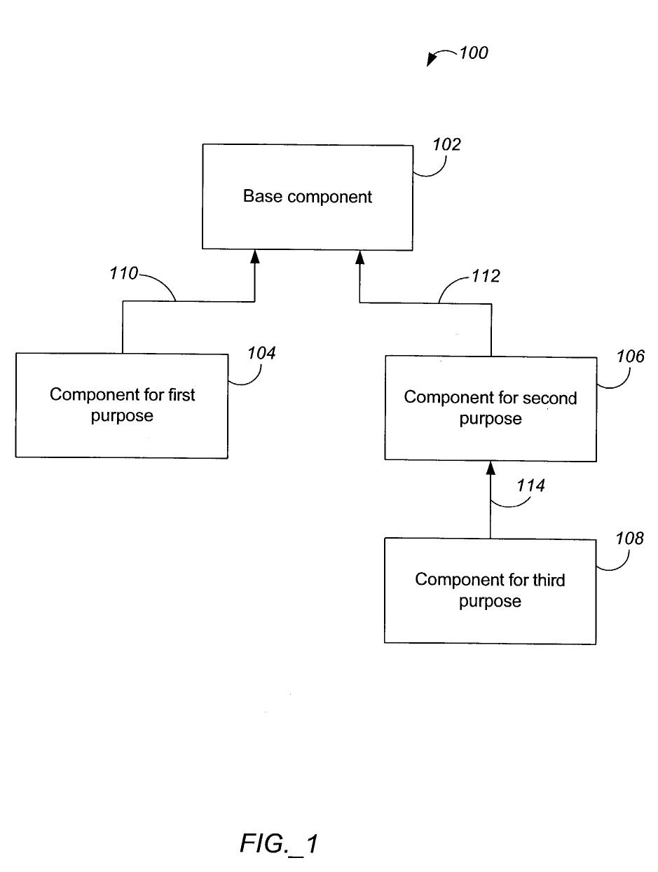

FIG. 1 shows a configuration model 100 that describes a product. The model includes a base component 102, a component 104 for a first purpose, a component 106 for a second purpose, and a component 108 for a third purpose. Alternatively, other components can be included for other purposes. The configuration model can have only a single component.

The base component 102 can describe characteristics of the product, characteristics values, constraints, prices of the product, costs of the product, and classes. As discussed above, a characteristic refers to some aspect, such as color, of the product. Characteristic values, such as blue, specify the aspect. For example, blue specifies the color of the product. Each of the components 104, 106, and 108 can also describe characteristics of the product, characteristic values, constraints, prices of the product, costs of the product, and classes.

The constraints describe dependencies between or among characteristics. Constraints can also serve other functions. A system can, for example, determine whether an instance of a configuration model is consistent and complete. The instance is consistent if all constraints of the model are satisfied. The instance is complete if all required characteristics and elements of the configuration model are included. Constraints are further described below.

Price refers to a monetary value at which a product is sold. Cost refers to a monetary value at which the product or its components are built or procured.

A class, in this specification, refers to a collection of similar objects. Cars that have two doors, for example, can be grouped in a class called coupes. Cars that have four doors, for example, can be grouped in a class called sedans. Each component can include one or more classes. For example, a base component of a configuration model for a car can have two classes of cars, sedans and coupes. Sedans can inherit information from and add information to cars. Similarly, coupes can inherit information from and add information to cars.

The configuration model can include links such as the link 110, the link 112, and the link 114. The links, which can be pointers, associate parent and child components. For example, the link 110 associates the base component 102 and the component 104. Furthermore, the link 110 specifies that the component 104 is a child of the base component 102.

A component can have multiple versions. A version is a particular storage state of the component. Documents, for example, can have different versions. The described links can associate versions of components. For example, the base component 102 and the component 104 can each have a first version and a second version, and the link 110 can associate the first versions of these components.

Child components can inherit from their respective parent components. That is, a child component can include all characteristics of the product, characteristic values, constraints, classes, prices of the product, and costs of the product. A child component generally further adapts the configuration model. For example, a child component, such as the component 108 can add a characteristic not included in a parent component, such as the component 106. The child component can also add one or more constraints to those of the parent component, as long as the new constraints do not contradict the constraints of the parent component. The child component can set or change default values for characteristics included in the parent component. The child component can restrict ranges of characteristic values included in the parent component.

A purpose, in the context of the specification, can be a goal or task to be completed. A purpose can be, for example, the completion of some process, such as a business process. Business processes can include processes for product design, marketing, production, sales, engineering, and so forth. A purpose can further be a goal or task to be completed by a particular entity. For example, a purpose can be a sales process of a particular sales organization.

A system that defines the configuration model 100 can present different views of the configuration model 100 to a user. The different views can include different information, depending on the purpose and, hence, the component. For example, when there are no purposes specified, the system can present a view that includes only information included in the base component. For the first purpose, the system can present a second view that includes information included in the base component 102 and the component 104.

The system can also determine which information to present to a user based on whether the user has authorization to view or change information. That is, the system can determine, based on a user's role and authorization, which component of the configuration model to use.

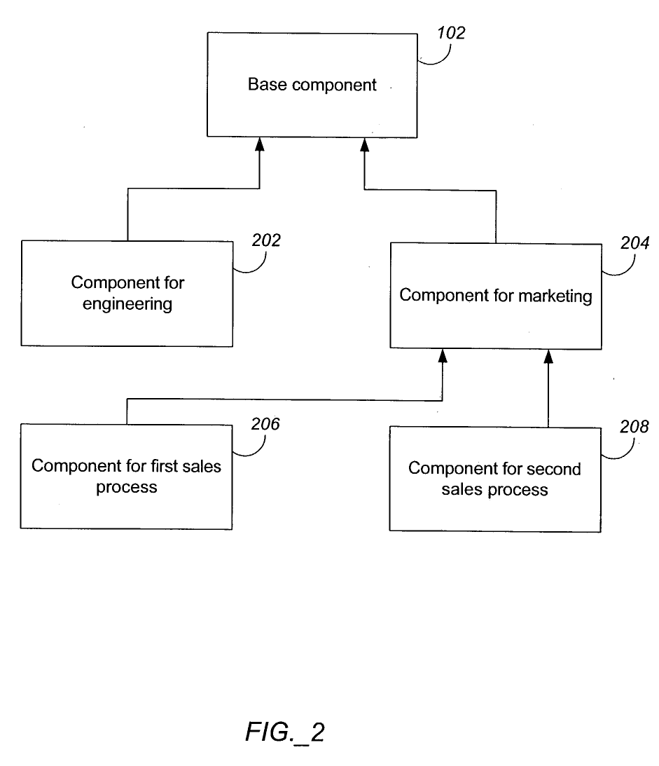

FIG. 2 shows an implementation of the configuration model 100. The implementation includes the base component 102, a component for engineering 202, a component for marketing 204, a component 206 for a first sales process, and a component 208 for a second sales process. The first sales process can be one that is for northern Europe. The second sales process can be one that is for southern Europe. Alternatively, the implementation can further include a component for engineering, a component for a particular production plant, and a component for product design. The components can be implemented as data objects.

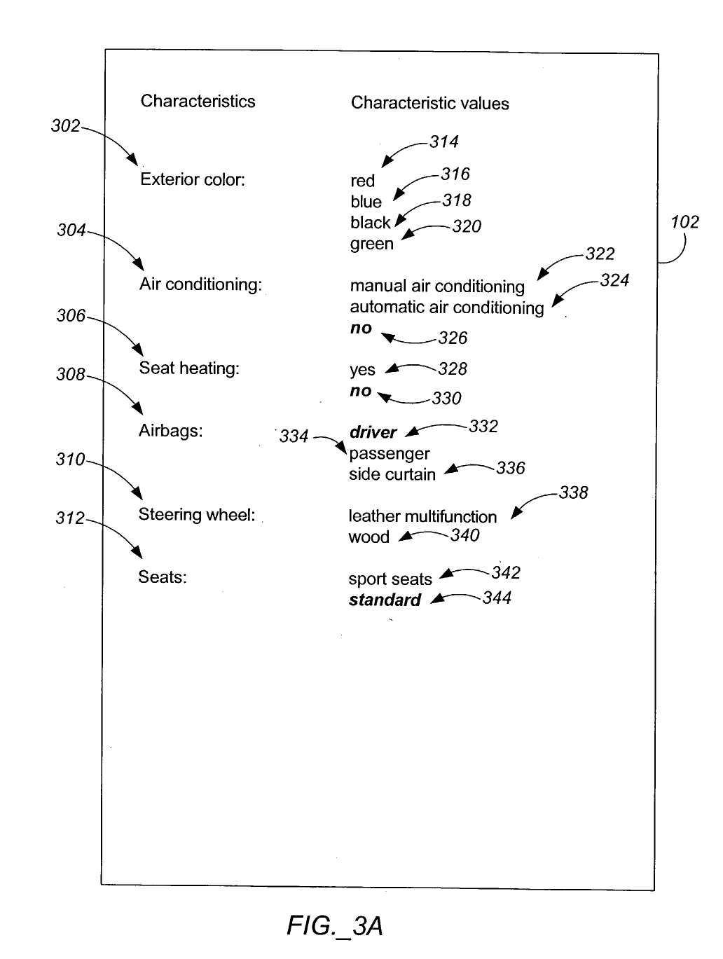

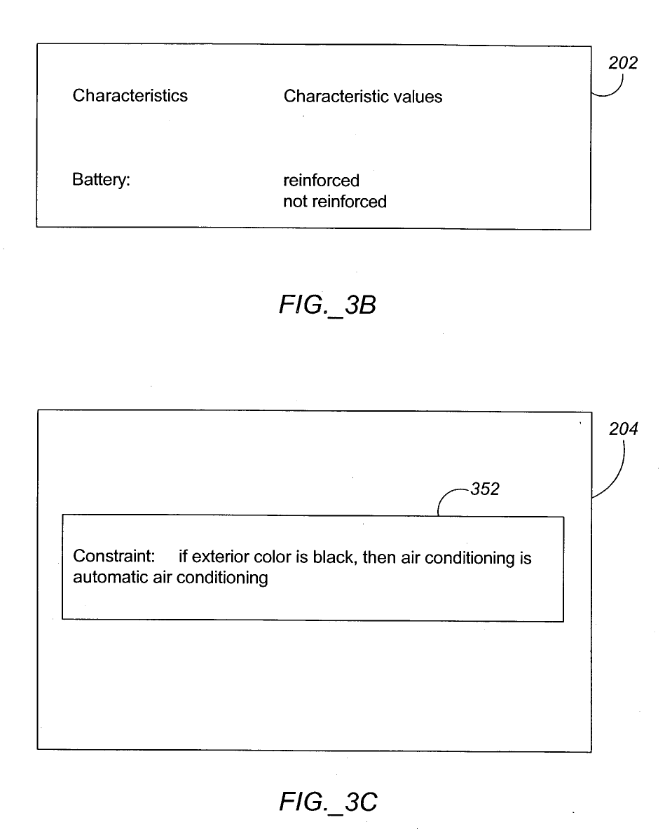

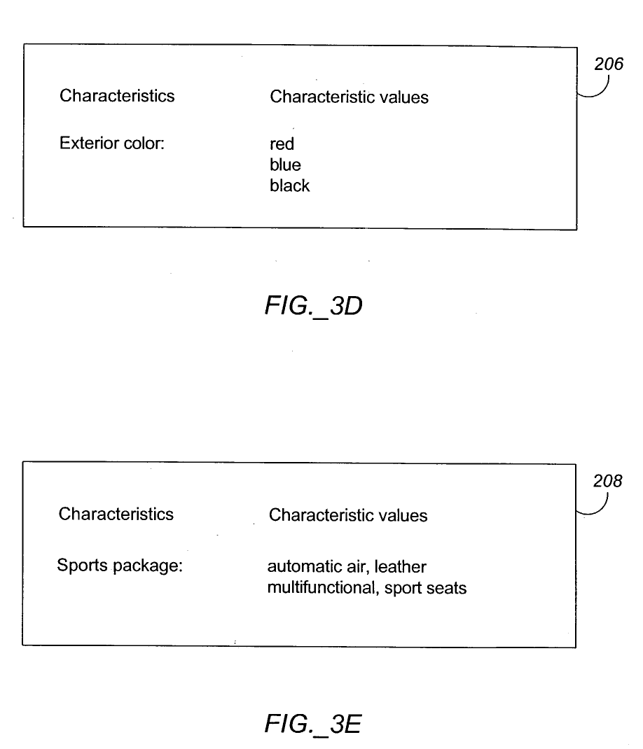

FIGS. 3A-E show examples of information included in the base component 102, the component for engineering 202, the component for marketing 204, the component 206 for the first sales process, and the component 208 for the second sales process. In the examples, the product is a car and the configuration model describes the car.

As shown in FIG. 3A, the basic component 102 includes characteristics and characteristic values. The characteristics include exterior color 302, air conditioning 304, seat heating 306, airbags 308, steering wheel 310, and seats 312. The characteristic values for color 302 include red 314, blue 316, black 318, and green 320. The characteristic values for air conditioning include manual air conditioning 322, automatic air conditioning 324, and no 326. The characteristic value for seat heating include yes 328 and no 330. The characteristic values for airbags include driver 332, passenger 334, and side curtain 336. The characteristic values for steering wheel include leather multifunction 338 and wood 340. The characteristic values for seats include sport seats 342 and standard seats 344.

Each component can also describe default values. For example, the default value for air condition is no, the default value for seat heating is no, the default value for airbags is driver, and the default value of seats is standard. In one implementation, default values can be inherited but cannot be overwritten.

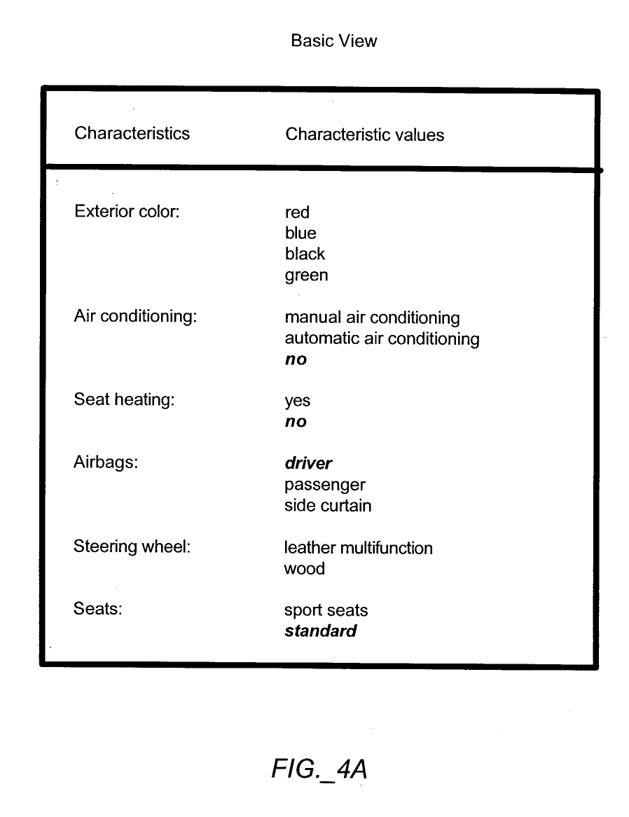

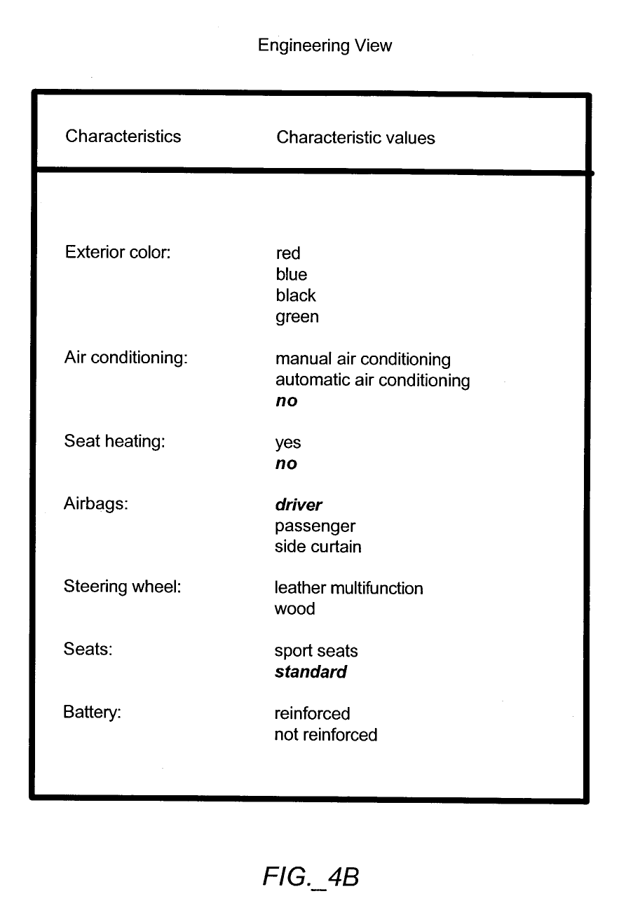

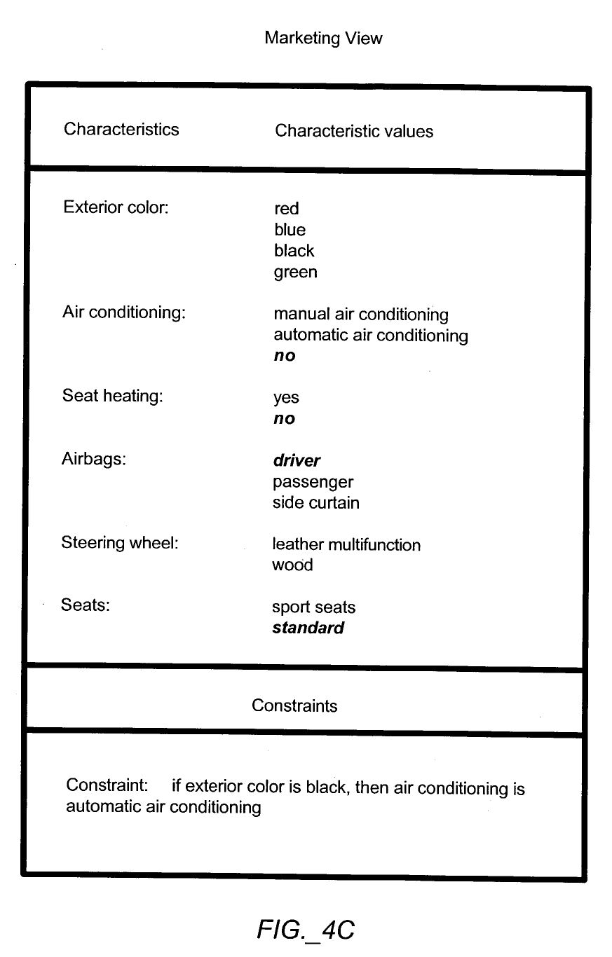

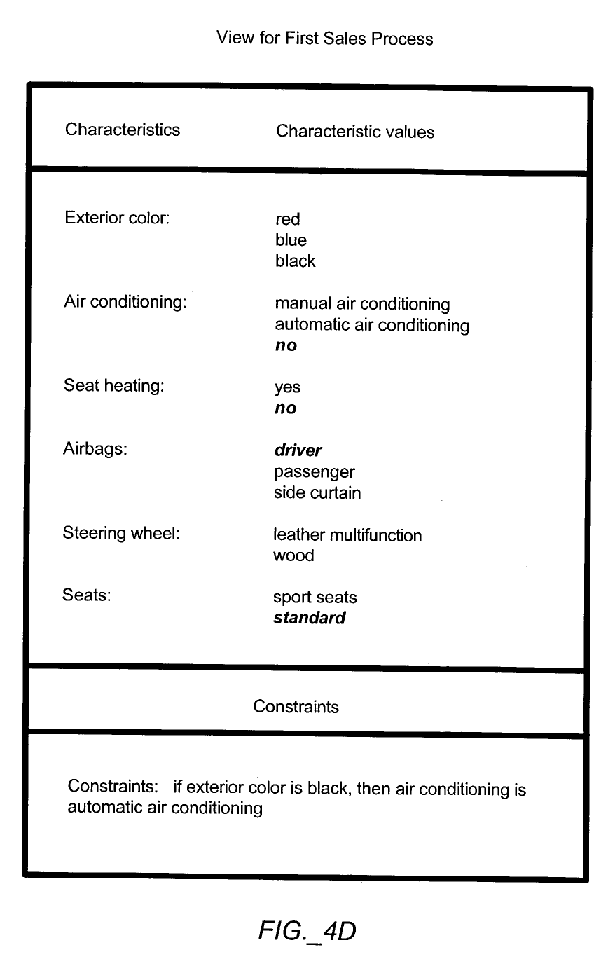

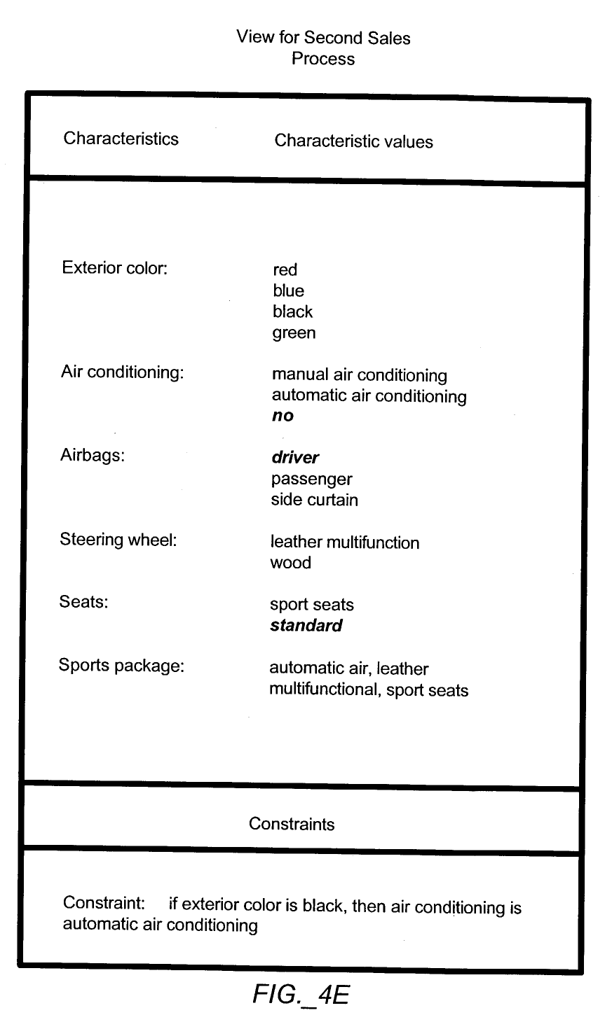

FIG. 4A shows an example view of base configuration model. The default values can be highlighted. A view of the base configuration model includes the above described characteristics and characteristic values.

As shown in FIG. 3B, the engineering component 202 includes an additional characteristic, such as battery 346, and additional characteristic values, such as reinforced 348 and not reinforced 350.

FIG. 4B shows an example view of the configuration model for engineering. A view of the engineering configuration model includes the characteristics and characteristic values of the base component 102 as well as the characteristic and characteristic values of the engineering component 202.

As shown in FIG. 3C, the marketing component 204 includes a constraint such as constraint 352. The constraint 352 specifies that there should be automatic air conditioning if the exterior color is black. FIG. 4C shows an example view of the configuration model for marketing. The view includes the characteristics and characteristic values included in the base component 102 and the constraint 352 included in the marketing component 204.

As shown in FIG. 3D, the component 206 for the first sales process has the same characteristics and constraint as the marketing component 204. However, the component 206 restricts the characteristic values for the exterior color. Specifically, the value green 320 has been excluded. FIG. 4D shows an example view of the configuration model for the first sales process.

As shown in FIG. 3E, the component 208 for the second sales process can include an additional characteristic, such as sports package 354, that have characteristic values of automatic air condition, leather multifunction, and sport seats. The defaults values of the component 208 are different from those described by the parent component, i.e., the marketing component 204. The default value for air conditioning is manual air instead of no, as is the case for the parent component. Some information, for example, the seat heating and its corresponding values, can be suppressed and, hence, are not shown in a corresponding view. Suppression hides but does not delete. FIG. 4E shows an example the view of the configuration model for the second sales process.

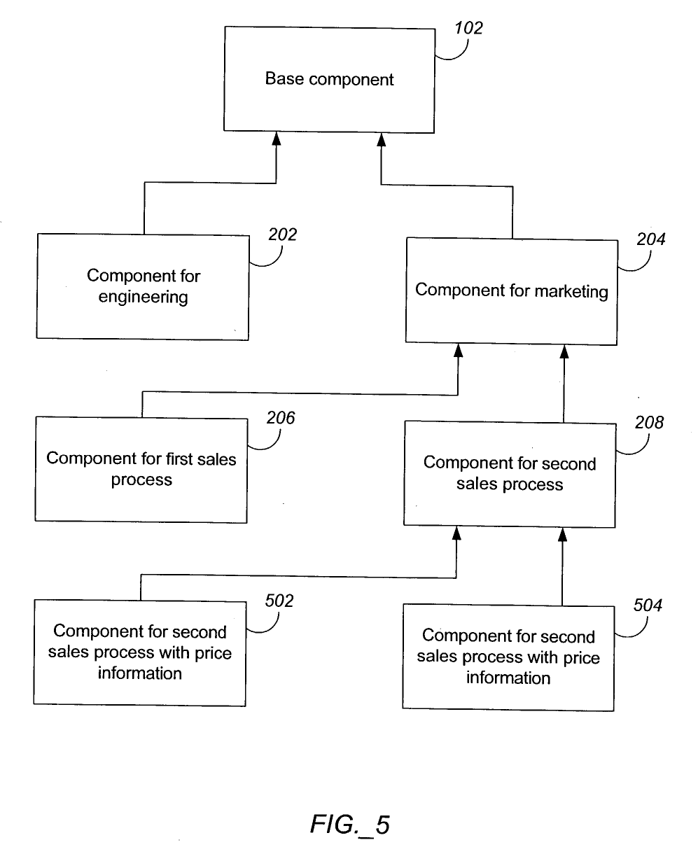

FIG. 5 shows another implementation of configuration model 100. In this implementation, the components can include information based on not only a business process but also on whether a user has authorization to access information. The implementation, for example, includes additional components 502 and 504 that include price information and, furthermore, which are only accessible to users having authority to view prices. Thus, users without authorization cannot access components 502 and 504 while users with authorization can access all components.

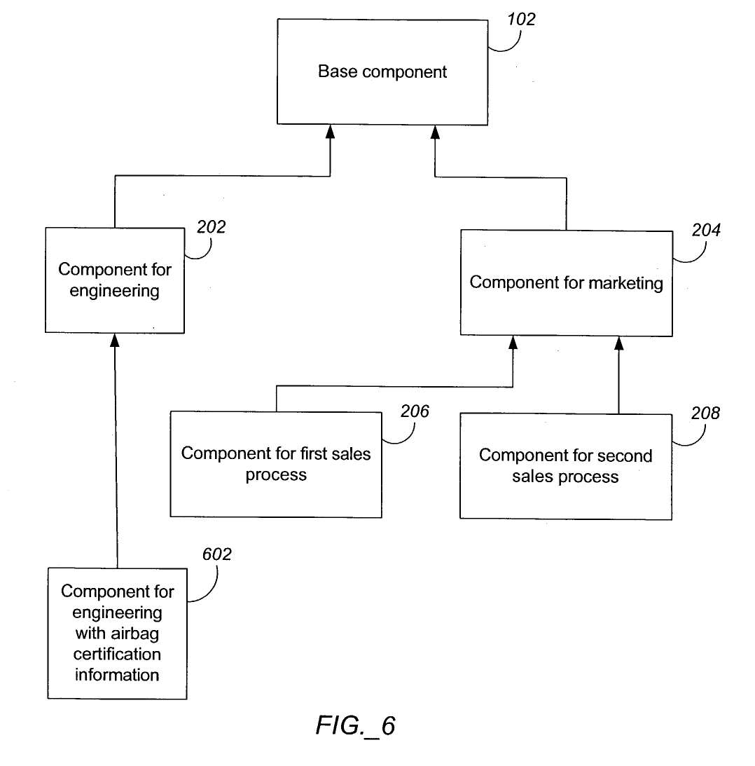

FIG. 6 shows another implementation of configuration model 100. In this implementation, the components can include information based not only on a business process but also on a role of the user. The implementation, for example, includes an additional component 602 that includes information about airbag certification. For users having a role that involves verifying airbags, the system presents information included in and inherited by the component 602. For users not having a role that involves certifying airbags, the system presents information inherited by and included in the component 202.

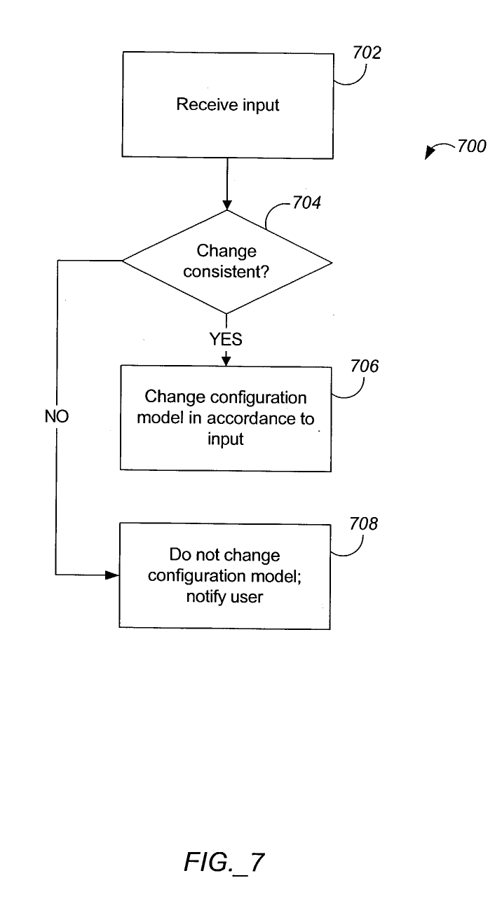

FIG. 7 shows a method 700 for configuring a configuration model. As shown, the system receives input (step 702). The input can request the addition of a component, in which case the request specifies an existing component from which the new component will depend. Furthermore, the input can request actions such as adding characteristics, adding constraints, restricting ranges, and setting defaults, in which case the request specifies the component or components in which the change is to be made. The input can be from a user or other sources such as a computing system.

Optionally, the system can determine whether the source of the input is authorized to request the action specified in the request is permissible. If there is no authorization, the system can deny access. If the source is authorized for the action, the system can proceed. The system can deny access based on role, authorization, or both. The system can also deny access because on object to be changed has been locked or is being modified by a different component of the configuration model.

The system checks consistency (step 704). Checking consistency includes verifying that existing constraints, ranges, and default values inherited and included in a component being changed are not violated by the action requested by the input. If the action maintains consistency, then the system changes the configuration model in accordance to the input (step 706). Otherwise, the system does not make the change and notifies the user that the input cannot be processed (step 708).

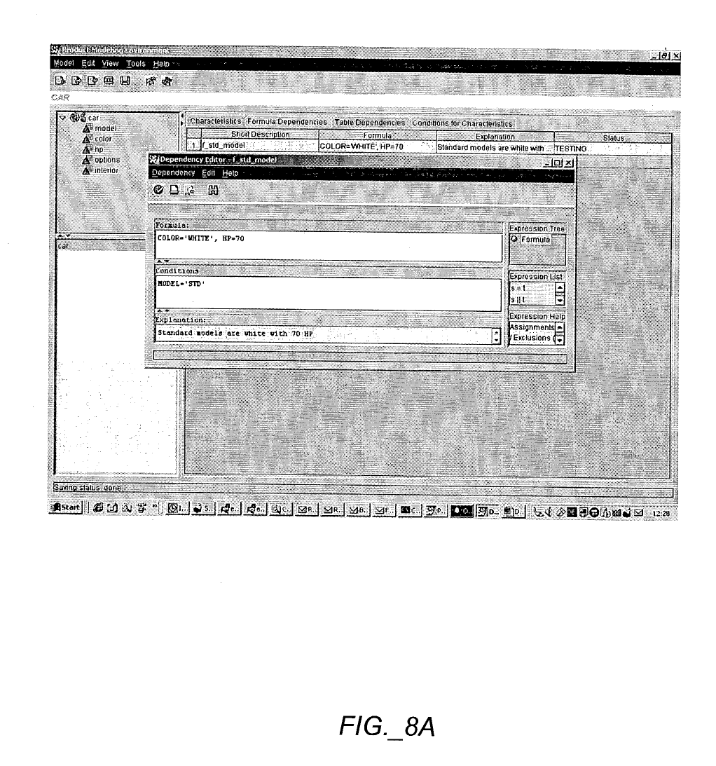

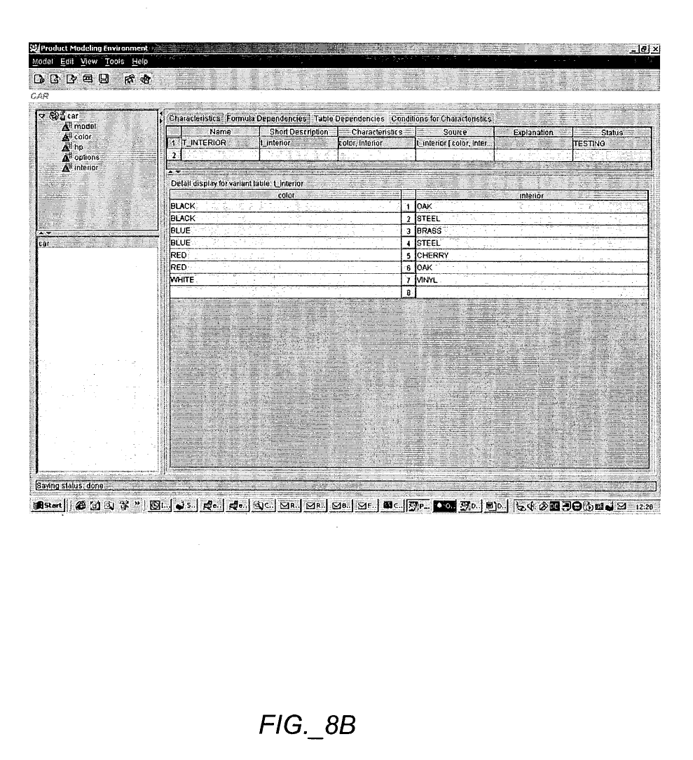

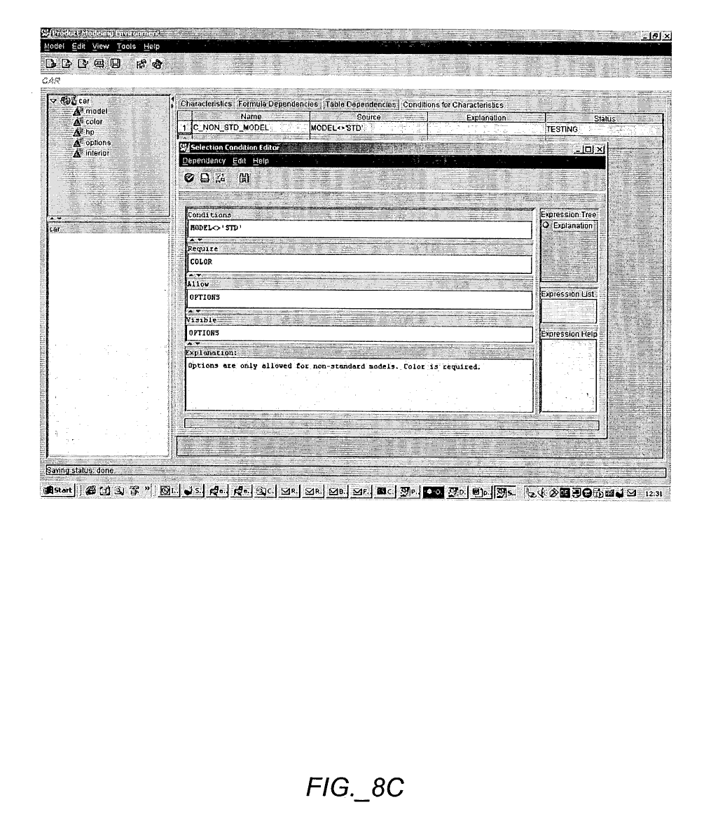

FIGS. 8A-C illustrates one implementation that includes three techniques for defining constraints (which are sometimes know as dependencies). The first technique uses formulas (also sometimes referred to as expressions). Generally, the formula is part of an IF-THEN statement. FIG. 8A shows a user interface that a user can use to define a constraint using the first technique. The user can enter into one window the IF (or the condition) part of the statement, which, in this example, is: if model is standard. The user can enter into another window the formula, which in this example, is: then color is white and horsepower is 70.

The second technique uses a table. As shown in FIG. 8B, the columns of the table can specify characteristics, such as colors and interior material, and the rows can specify characteristic values for the characteristics. Each row specifies a combination of characteristic values that is permissible. The table, thus, specifies all permissible combinations. For example, when exterior color is black, the interior material must be oak or steel.

The third technique uses conditions to specify which characteristics require characteristic values, which characteristics are allowed to have characteristic values, and which characteristics are shown in the configuration process. As shown in FIG. 8C, when model is not standard, for example, the characteristic called color is required and the characteristic called options is allowed and visible.

In one implementation, the configuration model includes: classes, characteristics, characteristic values, constraints, a product structure, configurable products, pricing information, estimated costs, and relationships between objects besides product structure. There can be more than one configuration model used in an enterprise. Typically configuration models encompass similar products, such as all products in a product family.

The configuration model can be linked with a master data system of a hosting system where applicable. Certain characteristics and characteristic values can refer to global definitions in the master data system. For example, a characteristic listing the customer, business partner, or other business context information of the configuration model can be linked to corresponding business objects in the master data system.

In one implementation, the system can define a way for processes connected in a process chain to communicate with each other by stipulating that a configuration passed from one process to the next must be consistent and complete with respect to a common ancestor component model. This defining is referred to, in this specification, as process completion and requires action by both processes. The process that is handing off (i.e., the handing process) must remove characteristics and components that are not common to the common ancestor component model. The handing process may need to translate the stripped information into additional objects and characteristic value assignments at the level of the common ancestor component model. In the example of the car a product sold in a particular sales region, e.g., a California Dune Buggy specified by 15 characteristic values, may not directly correspond to a manufactured model. The properties specified when ordering one such car should however enable identification of the car as a manufacturable model TX500 specified by some 50 characteristic values (which are not relevant for sales, but which can be inferred from the original 15 by the sales process).

The receiving process may have to augment the configuration by adding such characteristics and components from its own component model to allow useful processing. For example the TX500 derived by sales process in the above example may need to be built in a manufacturing plant. The manufacturing process needs additional details (like battery size). This information may lead to some 200 characteristic values to be set that can be derived from the passed 50 characteristics.

In one implementation, several model component versions can be concurrently used operationally by the associated business process or entities. For example, cars can be ordered some time ahead of intended delivery. Cars to be delivered in April may need to be configured against a different model from those to be delivered in June. When creating a new version of a model component an explicit decision must be made to release the model for business use. To this end, each model component has a status. If changes need to be made a model component that is in operational use these changes must be tested before allowing them to become active. For this end, each model component has an active and an inactive state. The inactive state can be changed and tested without affecting the operational version. If the changes pass the tests then the inactive state can be activated, which causes the version to be replaced.

In one implementation, model components are the units of distribution of a model. A central sales model may be distributed to all (non-central) sales organizations. Distributing a model component pre-supposes that the ancestor versions the component references either have already been distributed or are distributed along with the model component.

In one implementation, the system can provide a mechanism for importing and exporting model component versions. A data container that allows storing and shipping the data in a component is provided. Changes to a model component version can be exported and imported by them. When importing a change to a model component that is in operational use, the change may have to be imported in a staged way. It is first imported into the inactive state and later activated.

The invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a verification module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

The invention has been described in terms of particular embodiments. Other embodiments are within the scope of the following claims. For example, the steps of the invention can be performed in a different order and still achieve desirable results. The configuration model can be applied to any product and is not limited to those described. For example, the configuration model can describe configurable computer systems. The configuration model can be adapted for purposes other than those listed. For example, the configuration model can be adapted for a business process for advertising. The system can be any computing system that includes programs having instructions to perform the described actions and operations. A product model can include components other than the described configuration model and the product structure. For example, a product model can also include documents, routing information, line design information, and material information. The system can use any technique for defining constraints and is not limited to using those described in reference to FIGS. 8A-C.

What is claimed is:

1. A method implemented in a computer program application for changing a configuration model of a product, the method comprising:
receiving a configuration model, the configuration model including a first component and at least a second component, the first component including information for a first business process, the second component including information for a second business process, the information of the first and the second component including characteristics and characteristic values that describe the product and constraints specifying dependencies of the characteristics
receiving input that specifies a change to the configuration model; and
determining whether the change violates the characteristics and constraints of the configuration model.

2. The method of claim 1, wherein:
the change is a change to the second component;
the second component inherits characteristics and constraints from the first component; and
determining whether the change violates the characteristics and constraints includes determining whether the change violates characteristics and constraints that the second component inherits from the first component.

3. The method of claim 1, further comprising:
when the change does not violate characteristics and constraints, changing the configuration model in accordance with the input.

4. The method of claim 1, further comprising:
when the change does violate characteristics and constraints, not changing the configuration model in accordance with the input.

5. The method of claim 1, wherein:
receiving a configuration model includes receiving a configuration model that includes one or more components that have information which inclusion is based a role of a user.

6. The method of claim 1, wherein:
receiving a configuration model includes receiving a configuration model that includes one or more components that have information which inclusion is based on a user's access authorization.

7. The method of claim 1, wherein:
receiving a configuration model includes receiving a configuration model that includes one or more constraints for determining whether a user can make the change specified by the input.

8. The method of claim 1, wherein:
receiving a configuration model includes receiving a configuration model in which the first component is a base component and the second component is one of a marketing component, a design component, an engineering component, a sales component, and a production component.

9. A computer program product, tangibly stored on a machine-readable medium, for defining a configuration model for a product, comprising instructions operable to cause a programmable processor to:
receive input;
define, based on the input, a base component of the configuration model, the base component including information that describes the product; and
define, based on the input, a first component of the configuration model, the first component including information that describes the product and that is associated with a first business process.

10. The product of claim 9, further comprising instructions to:
generate a first view of the configuration model, the first view including information that describes the product; and
generate a second view of the product, the second view including information that describes the product and that is associated with a first business process.

11. The product of claim 9, further comprising instructions to:
define, based on the input, a second component of the configuration model, the second component including information which inclusion is based on a role of a user.

12. The product of claim 9, further comprising instructions to:
define, based on the input, a second component of the configuration model, the second component including information which inclusion is based on an access authorization.

13. The product of claim 9, wherein:
the information that describes the product includes any combination of characteristics, characteristic values, constraints describing dependencies of the characteristics, default values, and values ranges.

14. The product of claim 9, wherein:
the information that is associated with the first business process includes any combination of characteristics, characteristic values, constraints, default values, and values ranges.

15. The product of claim 14, wherein:
the constraints include constraints for describing dependencies of characteristics.

16. The product of claim 9, wherein:
the first business process is one of marketing, product design, production, engineering, and sales.

17. The product of claim 9, wherein the input requests adding a second component that is to be a child of the first component and, furthermore, that includes information for a second business process, the product further comprising instructions to:
check that the information included in the second component does not violate information included in the first component.

18. The product of claim 16, further comprising instructions to:
generate a third view of the configuration model, the third view including information included in the first component and information included in the second component.

19. A method implemented in a computer program application for modeling a product, the method comprising:
defining a configuration model, the configuration model including a first component and at least a second component, the first component including information for a first business process, the second component including information for a second business process, the information of the first and the second component including one or more of characteristics and characteristic values that describe the product and rules specifying dependencies of the characteristics, the first business process defining a baseline configuration for the product and the second business process defining a variation from the baseline configuration;
receiving input that specifies a change to the configuration model; and
determining whether the change violates the characteristics and rules of the configuration model.

20. A computer program product, tangibly stored on a machine-readable medium, for defining a configuration model for a product, comprising instructions operable to cause a programmable processor to:
receive input;
define, based on the input, a base component of the configuration model, the base component including information that describes a baseline configuration for the product; and
define, based on the input, a first component of the configuration model, the first component including information that describes a variation to the baseline configuration of the product and that is associated with a first business process, where the first component includes restrictions on accessing and modifying the variation information.
